(19) United States
(12) Patent Application Publication
(10) Pub. No.: US 2023/0373636 A1
(43) Pub. Date: Nov. 23, 2023

(54) Decentralized Control Panel Architecture

(71) Applicant: Safran Passenger Innovations, LLC, Brea, CA (US)

(72) Inventor: Andreas Rochau, Wessling (DE)

(73) Assignee: Safran Passenger Innovations, LLC, Brea, CA (US)

(21) Appl. No.: 17/746,609

(22) Filed: May 17, 2022

(51) Int. Cl. B64D 13/06

(52) U.S. Cl. CPC B64D 13/06; B64D 2013/0625; B64D 2013/064

(57) ABSTRACT

Systems and methods are described herein that utilize a decentralized control panel architecture to monitor or control components or (sub-)systems of an aircraft or other vehicle. A controller can be used to receive information from multiple input sources and send a command to one or more output devices based on the received information. The received information may be of different types or formats that can be read by the controller. The controller may cause a visual or physical change to an actuator based on the command. One or more control panel entities can be communicatively coupled with the controller and used to access information about one or more (sub-)systems of the vehicle and send commands where appropriate.

### FIELD OF THE INVENTION

The field of the invention is control panels, and specifically, control panels for use with various systems within a vehicle.

### BACKGROUND

The following description includes information that may be useful in understanding the present invention. It is not an admission that any of the information provided herein is prior art or relevant to the presently claimed invention, or that any publication specifically or implicitly referenced is prior art.

In vehicle systems, control panels are typically tied to the system they control. For example, the controls panels and control elements are often “hard wired” to their mother system, resulting in a dedicated control panel for each system that is often installed in a central location. The existence of dedicated control panels for each system can be undesirable as each control panel requires its own physical space, the central location of all of the control panels reduces flexibility during planning and installation, and the different control panels often utilize different control schemes and paradigms, thereby increasing their overall complexity.

The central location can limit access opportunities for crew members throughout an aircraft or other vehicle, for example, and can limit operational efficiencies. In addition, in most vehicles, space is a premium. With aircraft in particular, each component adds to the overall weight of the aircraft, which increases the amount of fuel required to fly the aircraft.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for systems and methods that utilize a decentralized control panel architecture to operate or manage disparate subsystems or components in a vehicle.

### SUMMARY OF THE INVENTION

The inventive subject matter provides apparatus, systems, and methods for a decentralized control panel architecture to manage and control various subsystems of a vehicle. Contemplated vehicles include, for example, aircraft, busses, trains, cars, ferries, and other boats. Through the availability of wired/wireless links and adequate processing power, a decentralized crew panel architecture can be realized that eliminates the many disadvantages described above.

Contemplated systems and methods for monitoring or controlling components of a vehicle may comprise a controller having a processor and memory, wherein the controller is communicatively coupled to a plurality of input devices and a plurality of output devices, such that signals, queries, commands, and other data can be received and transmitted to and from the controller to at least some of the plurality of input devices and the plurality of output devices.

The processor can undertake a variety of functions including, for example, data collection, data interpretation, data processing and encoding of control signals; the storage of data for later retrieval; rendering of user interfaces for a display; translating control inputs into control commands; arbitration in case of conflicting control inputs; performing access rights management; and so forth.

Preferably, the plurality of input devices comprises at least one input device, and more preferably, at least a first input device and a second input device. It is contemplated that each of the plurality of input devices is disposed within the vehicle. It is further contemplated that the first input device is a component of a first subsystem of the vehicle and the second input device is a component of a second, different subsystem of the vehicle. In some embodiments, the first input device is configured to transmit data in a first format and the second input device is configured to transmit data in a second format that is different from the first format.

Preferably, at least some of the plurality of input devices including the first or second input device is configured to monitor at least one of an operational status of a component of the vehicle, a configuration status of the component of the vehicle, an equipment status of the component of the vehicle, a passenger request, and a passenger interaction.

Critically, the controller is configured to receive and analyze data in both of the first and second formats, so that a single controller can be used to monitor and control the devices of multiple subsystems of the vehicle without the need for multiple, disparate controllers.

In addition, it is contemplated that the controller can be accessed from various devices which may include portable computing devices such as a tablet PC or dedicated crew panels or other components installed within the vehicle. Thus, the configuration permits the crew of a vehicle or other personnel to access information and control various systems or subsystems of a vehicle from multiple locations and potentially even outside of the vehicle itself.

As used herein, the term “portable computing device” is defined to include laptop computers, tablet PCs, smart phones including, for example, those running APPLE iOS™ or ANDROID™ operating software, smart watches, smart glasses such as GOOGLE glass or their equivalent capable of displaying augmented reality elements to a user wearing the glasses, and all other portable devices that can connect to a network and receive and/or transmit information from or to a server.

In some embodiments, each of the plurality of output devices is disposed within the vehicle and the plurality of output devices comprises a first output device and a second output device. Contemplated output devices include, for example, a light source, a wireless access point, a HVAC subsystem, an overhead display, a seat-specific display, a power source, a passenger seat, a status indicator, a satellite communication system, a computing device, and other devices of the vehicle.

The controller is preferably configured to analyze the received data from the first and second input devices and transmit a first command to the first output device based on the data received from the first or second input device.

The systems and methods discussed herein that utilize the decentralized control panel architecture allow multiple connections to be supported to communicate with sensors, actuators, control panel entities and other devices or components of the vehicle. The use of multiple control panel entities allows multiple users to monitor and control (sub-)systems through a wired or wireless distribution system as they are not tied to a fixed location in the vehicle.

The inventive concepts discussed herein allows a crew member to monitor and control one or more (sub-)systems throughout the cabin or vehicle interior, such as by using a tablet PC, smartphone, or other portable computing device. This thereby increases the flexibility of the crew members and the operational efficiencies.

In addition, the described concepts reduce the overall space required for control panel entities in the vehicle, allow multiple crew members to monitor and control vehicle (sub-) systems at the same time from anywhere in the vehicle, facilitate remote monitoring of the (sub-) systems outside of the vehicle through virtualization, manage all of the data from the various (sub-)systems through a single controller instance, and more.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 illustrates a schematic of one embodiment of a system for monitoring and controlling various (sub-)systems of a vehicle.

FIG. 2 illustrates a schematic of another embodiment of a system for monitoring and controlling various (sub-)systems of a vehicle.

### DETAILED DESCRIPTION

Throughout the following discussion, numerous references will be made regarding servers, controllers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The terms, “controller”, “component”, “module”, “system”, and similar terms used in the present specification indicate a computer-related entity, hardware, firmware, software, a combination of software and hardware, or execution of software. For example, a component may be a procedure executed in a processor, a processor, an object, an execution thread, a program, and/or a computer, but is not limited thereto. For example, both an application executed in a computing device and a computing device may be components. One or more components may reside within a processor and/or an execution thread. One component may be localized within one computer. One component may be distributed between two or more computers. Further, the components may be executed by various computer readable media having various data structures stored therein. For example, components may communicate through local and/or remote processing according to a signal (for example, data transmitted to another system through a network, such as the Internet, through data and/or a signal from one component interacting with another component in a local system and a distributed system) having one or more data packets.

Those skilled in the art shall recognize that any illustrative logical blocks, configurations, modules, circuits, means, logic, and algorithm operations described in relation to the embodiments disclosed herein may be implemented by electronic hardware, computer software, or in a combination of electronic hardware and computer software. In order to clearly exemplify interchangeability of hardware and software, the illustrative components, blocks, configurations, means, logic, modules, circuits, and operations have been generally described above in the functional aspects thereof. Whether the functionality is implemented as hardware or software depends on a specific application or design restraints given to the general system. Those skilled in the art may implement the functionality described by various methods for each of the specific applications. However, it shall not be construed that the determinations of the implementation deviate from the range of the contents of the present disclosure.

Embodiments of the inventions described herein may include or utilize a special purpose or general-purpose computer that includes one or more servers and/or other computer hardware. The one or more servers can each include, for example, one or more processors and system memory. The computer can also include physical and other computer-readable media for carrying or storing computer-executable instructions and/or data structures. Such instructions can facilitate the systems and methods described and may be stored in a non-transitory computer-readable medium and executable by the one or more servers or other computing devices. As an example, a processor may receive instructions from a non-transitory computer-readable medium and execute those instructions to perform one or more processes.

Computer-readable media can be any available media that can be accessed by a general purpose or special purpose computer system. Examples of computer-readable media include RAM, ROM, EEPROM, solid state drives, Flash memory, and other optical disk storage, magnetic disk storage or other magnetic storage devices, or any other medium which can be used to store desired application code in the form of computer-executable instructions or data structures, and which can be accessed by a general purpose or special purpose computer.

Computer-executable instructions include, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure including the controllers described herein can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

The systems and methods described herein may utilize various communication protocols including, for example, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Message Queuing Telemetry Transport (“MQTT”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

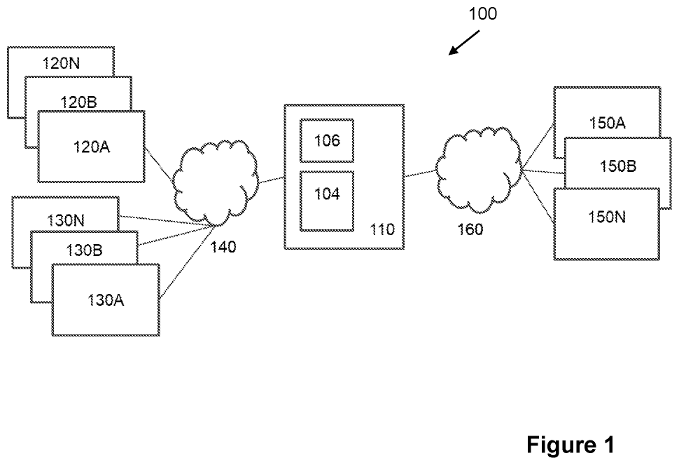

FIG. 1 illustrates one embodiment of a system 100 comprising a control panel architecture for monitoring or controlling of components or subsystems of a vehicle can include a controller 110 having a memory 104 and a processor 106. Preferred systems eliminate the need for a centralized physical control panel by utilizing a decentralized control panel architecture. The memory 104 preferably comprises a non-transitory computer readable storage medium for monitoring or controlling of components or subsystems of a vehicle that includes the controller 110. The non-transitory computer readable storage medium preferably comprises a computer program that comprises instructions to facilitate the monitoring or controlling of components or subsystems of the vehicle.

It is contemplated that the processor 106 and/or memory 104 could be disposed in a single physical unit such as a server acting as the controller 110 or could be disposed in separate locations and collectively comprise the controller 110. In addition, the processor 106 and/or memory 104 may be deployed physically or virtualized (e.g., on other hardware, inside or outside the vehicle). Virtualization allows the controller 110 to be hosted “in the cloud” such as described above, such that the controller can be accessed from virtually anywhere. The decentralized configuration of the controller 110 described herein allows the controller 110 to be virtualized and deployed anywhere which opens up use cases to monitor and control vehicle (sub-)systems from inside or outside the aircraft or other vehicle.

Contemplated subsystems of a vehicle include, for example, in-flight or in-vehicle entertainment, connectivity, cabin control and so forth.

The controller 110 is configured to collect data from sensors and (sub-)systems through wired or wireless connections. After the data is collected, the controller 110 can interpret and process the data using the processor 106 and, if needed, store the data in the memory 104 or in a separate server. The stored data can then be used for performance evaluation or predictive maintenance purposes, which may be conducted by the controller 110. The controller 110 can also be configured to control actuators and (sub-)systems through wired or wireless connections.

The controller 110 is communicatively coupled with a plurality of devices, which can include a plurality of input devices 120 and a plurality of output devices 130. Preferably, each of the plurality of input devices 120 is disposed within the vehicle. In some embodiments, the plurality of input devices 120 comprises a first input device 120A and a second input device 120B. Because the input devices 120 may be associated with different (sub-)systems of the vehicle, the first input device 120A may be configured to transmit data in a first format and the second input device 120B may be configured to transmit data in a second format that is different from the first format. In such embodiments, it is contemplated that the first input device 120A is a component of a first subsystem of the vehicle and the second input device 120B is a component of a second, different subsystem of the vehicle. Traditionally, this would require separate controllers to monitor and control each (sub-)system. Advantageously, by using the inventive concepts described herein, the controller 110 is able to receive and analyze information in a variety of different formats and transmit commands to a plurality of different output devices 130.

It is contemplated that some of the devices could comprise both an input device and an output device. For example, a portable computing device can be used to interact with the controller 110 by transmitting a command to the controller (an input) and receiving information (an output) form the controller 110 about one or more (sub-)systems of the vehicle.

The plurality of output devices 130 preferably comprises a first output device 130A and a second output device 130B. It is preferred that each of the plurality of output devices 130 is disposed within the vehicle, although it is contemplated that one or more of the plurality of output devices 130 may be remotely connected to the controller 110 and disposed outside of the vehicle.

It is contemplated that the controller 110 can be coupled with the plurality of input devices 120 and the plurality of output devices 130 via wired or wireless connection(s) which may collectively comprise network 140. The connection(s) may comprise any transport medium or protocol known in the art or derived therefrom. Examples include near-field communications, Bluetooth™ and other short-range wireless communication standards (e.g. “Wi-Fi”) or protocols, infrared, light radio, mobile telecommunication standards such as those developed by the 3rd Generation Partnership Project (3GPP), MQ Telemetry Transport (MQTT), Simple Network Management Protocol (SNMP), Rest API, serial Interface, HTML, Digital I/Os, as well as proprietary protocols. Thus, it is contemplated that some of the input devices and/or output devices may be wirelessly connected to the controller 110, while others may be connected via a wired connection or a hybrid (wired/wireless) connection.

It is contemplated that at least one of the input devices could comprise a sensor, which monitors an environment or (sub-)system of the vehicle and transmits a signal or other information to the controller 110. The input devices may comprise sensors and other devices across various (sub-)systems of the vehicle. For example, aircraft and other vehicle (sub-) systems can generate a multitude of data sets from a multitude of devices and other components that is transmitted to the controller 110 to be analyzed and/or stored. Such data may include, for example, an operational status (e.g., faults, errors, etc.); a configuration status (e.g., Wi-Fi channels); an equipment status (e.g., seat position, seat belt position, TTL readiness, etc.); BIT/BITE Status of one or more components of the vehicle; wear and tear data (e.g., counters, predictive maintenance data); passenger requests and interactions (e.g., meal service); and so forth.

The controller 110 receives data from each of the plurality of input devices 120 including the first input device 120A and the second input device 120B and is configured to analyze the received data and transmit a first command to at least a first output device 130A of the plurality of output device 130 based on the data received from the first input device 120A or the second input device 120B. It is further contemplated that the first command, a different command, or information can be transmitted to a second output device 130B or others of the plurality of output devices 130. Put another way, the controller 110 can gather information from one or more of the plurality of input devices 120, which may include status information, setting information, testing information, and so forth. Using this information, the controller 110 can then directly or indirectly control actuators and others of the plurality of output devices 130, which may include lighting systems, in-flight entertainment systems, HVAC systems, seats, indicator lights or signage, and so forth. For example, the system 100 could combine one or more HVAC systems into a single control panel architecture using controller 110. This would advantageously eliminate the use of multiple control panels for the multiple systems

In addition, the controller 110 is configured to process and prepare data (received or generated) in a manner such that more than one control panel entity 150A-150N can access the data over a network 160. As used herein, the term “control panel entity” means a portable computing device or dedicated hardware installed in the vehicle that may have dedicated indications or controls (e.g., switches, LEDs, etc.), both of which can be used to access data about one or more of the vehicle's (sub-)systems. Network 160 can collectively comprise one or more wired or wireless connections existing between the controller 110 and the control panel entities 150A-150N. Although network 160 is shown distinct from network 140, it is contemplated that a single network could be used to communicate with all of the referenced components rather that separate networks.

The use of or ability to use multiple control panel entities 150A-150N allows for multiple instances of a control panel to exist at the same time, and further allows for the tailoring of each of the control panels functions based on the user and/or its purpose. Thus, multiple users can monitor or control the vehicle's (sub-)systems at the same time individually and independently from each other, if desired, resulting in additional flexibility and a higher operational efficiency than exists in the prior art known to Applicant.

It is further contemplated that the controller 110 can receive commands or queries from one or more of the control panel entities 150A-150N, which may be encoded into control commands for one or more of the plurality of output device 130 or other components of the vehicle. In such embodiments, the controller 110 may also be configured to perform arbitration where conflicting control commands are received from multiple ones of the control panel entities 150A-150N.

In some embodiments, the controller 110 can be configured to render a user interface on one or more of the control panel entities 150A-150N, such as through a web server. This advantageously can reduce the computational power and capabilities required by the control panel entity. In this manner, different interfaces can be dynamically generated by the controller 110 which may be tailored for the specific use that could depend on the specific control panel entity as well as the user accessing the control panel entity. Thus, a control panel entity may display a subset a function for one purpose (e.g., HVAC controls) that can differ from a different subset of functions for a different purpose (e.g., in-flight entertainment controls). The rendering of status/control information from a common source also facilitates a common control paradigm and philosophy, thereby eliminating inefficiencies due to varying implementation of control functions that would occur between multiple systems and their associated learning curves.

In some embodiments, the controller 110 can also be configured to associate the data with access rights and perform access right management to limit what status/control elements are accessible to each user, each output device, and/or each control panel entity 150A-150N.

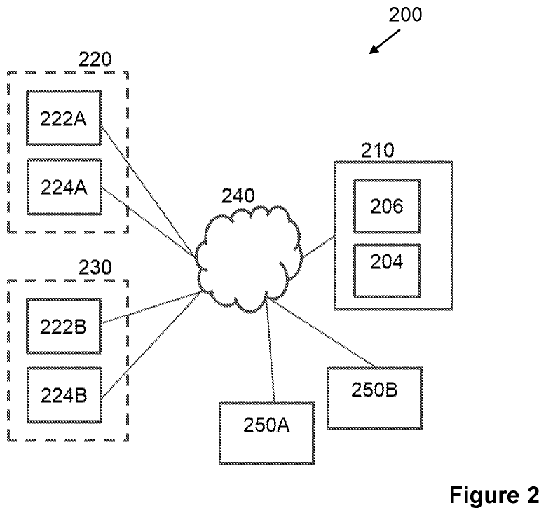

FIG. 2 illustrates one embodiment of a system 200 comprising a control panel architecture for monitoring or controlling of components or (sub-)systems of a vehicle. The system 200 comprises a decentralized controller 210 comprising a memory 204 and a processor 206. It is preferred that the system 200 utilizes a decentralized control panel architecture and thereby eliminates the need for a centralized physical control panel. The memory 204 preferably comprises a non-transitory computer readable storage medium for monitoring or controlling of components or subsystems of a vehicle that includes the controller 210. The non-transitory computer readable storage medium preferably comprises a computer program that comprises instructions to facilitate the monitoring or controlling of components or subsystems of the vehicle.

It is contemplated that the processor 206 and/or memory 204 could be disposed in a single physical unit such as a server acting as the controller 210 or could be disposed in separate locations and collectively comprise the controller 210. In addition, the processor 206 and/or memory 204 may be deployed physically or virtualized (e.g., on other hardware, inside or outside the cabin). As discussed above with respect to system 100, virtualization allows the controller 210 to be hosted “in the cloud” such as described above, such that the controller can be accessed from virtually anywhere. The decentralized configuration of the controller 210 described herein allows the controller 210 to be virtualized and deployed anywhere which opens up use cases to monitor and control vehicle (sub-)systems from inside or outside the aircraft or other vehicle.

Contemplated subsystems of a vehicle include, for example, in-flight or in-vehicle entertainment, connectivity, cabin control and so forth.

The controller 210 is configured to collect data from at least a first subsystem 220 and a second subsystem 230 of the vehicle.

The first subsystem 220 preferably comprises a first input device 222A which is communicatively coupled with the controller 210 via the network 240, where the network 240 may comprise one or more wired or wireless connection(s) or combination thereof. Exemplary connections include those discussed above. Preferably, the first input device 222A comprises a sensor configured to (i) monitor a status of the first subsystem 220 of the vehicle and (ii) generate data to be transmitted to the controller 210. It is contemplated that the first input device 222A may be configured to monitor at least one of an operational status of a component of the vehicle, a configuration status of the component of the vehicle, an equipment status of the component of the vehicle, a passenger request, and a passenger interaction.

The second subsystem 230 preferably comprises a second input device 222B which is communicatively coupled with the controller 210 via the network 240, where the network 240 may comprise one or more wired or wireless connection(s) or combination thereof. Exemplary connections include those discussed above. It is contemplated that the first input device 222B may be configured to monitor at least one of an operational status of a component of the vehicle, a configuration status of the component of the vehicle, an equipment status of the component of the vehicle, a passenger request, and a passenger interaction.

Because the input devices are associated with different subsystems of the vehicle, the first input device 222A may be configured to transmit data in a first format and the second input device 222B may be configured to transmit data in a second format that is different from the first format. Advantageously, by using the inventive concepts described herein, the controller 210 is able to receive and analyze information in a variety of different formats from the first input device 222A and the second input device 222B and transmit commands to the first output device 224A and the second output device 224B.

In some embodiments, it is contemplated that one of the first input device 222A and the second input device 222B comprises a control panel entity that is configured to receive an input from a user and transmit data to the controller 210 based on the input. In such embodiments, it is contemplated that the control panel entity may also comprise a first output device 224A or a second output device 224B, where the first output device 224A or the second output device 224B is configured to display information based on a received first command from the controller 210.

The controller 210 is configured to collect data from the first input device 222A and the second input device 222B. The controller can interpret, encode, analyze and/or process the data using the processor 206, and, if needed, store the data in memory 204 or a separate memory. As discussed above, the stored data can then be used for performance evaluation or predictive maintenance purposes, which may be conducted by the controller 210.

Based on at least some of the received data, the controller 210 is preferably configured to send a control command to at least one of the first output device 224A and the second output device 224B via the network 240. In some embodiments, the first output device 224A comprises an actuator which can thereby be controlled by the controller 210 through a wired or wireless connection. In such embodiments, it is contemplated that the first output device 224A or actuator causes a visual or physical change to the first output device 224A or the subsystem 220 based on a received command from the controller 210. Such change could include powering on or off a light source, changing a status indicator, powering on or a HVAC unit, powering on or off a wireless network or a wireless access point of the network, and so forth.

As a simplistic example, the first input device 222A could comprise a thermometer that reads a temperature within the vehicle, and the controller 210 could send a command to a first output device 224A, which could comprise a thermostat or other actuator of a HVAC subsystem. Other contemplated output devices can include, for example, a light source, a wireless access point, a HVAC subsystem, an overhead display, a seat-specific display, a power source, a passenger seat, a status indicator, or other components of the aircraft or other vehicle.

The controller 210 may also be communicatively coupled with one or more control panel entities 250A, 250B via a wired or wireless connection of the network 240. For example, a first control panel entity 250A may comprise a portable computing device can be used to interact with the controller 210 by transmitting a command to the controller (an input) and receiving information (an output) from the controller 210 about one or more (sub-)systems of the vehicle.

The use of or ability to use multiple control panel entities 250A, 250B allows for multiple instances of a control panel to exist at the same time, and further allows for the tailoring of each of the control panels functions based on the user and/or its purpose. Thus, multiple users can monitor or control the vehicle's (sub-)systems at the same time individually and independently from each other, if desired, resulting in additional flexibility and a higher operational efficiency than exists in the prior art known to Applicant.

The controller 210 receives data from the first input device 222A and the second input device 222B, analyzes the received data, and transmits a first command to the first output device 224A based on the data received from the first input device 222A or the second input device 222B. It is further contemplated that the first command, a different command, or information can be transmitted to a second output device 224B. The information may include status information, setting information, testing information, or other pertinent information. Using this information, the controller 210 can then directly or indirectly control actuators and other output devices, which may include lighting systems, in-flight entertainment systems, HVAC systems, seats, indicator lights or signage, and so forth.

It is further contemplated that the controller 210 can receive commands or queries from at least one of the control panel entities 250A, 250B. In some embodiments, the controller 210 can be configured to render a user interface on one or both of the control panel entities 250A, 250B, such as through a web server. This advantageously can reduce the computational power and capabilities required by the control panel entity. In this manner, different interfaces can be dynamically generated by the controller 210 which may be tailored for the specific use that could depend on the specific control panel entity as well as the user accessing the control panel entity.

As discussed above, the controller 210 can also be configured to associate the data with access rights and perform access right management to limit what status/control elements are accessible to each user, each output device, and/or each control panel entity 250A, 250B.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system for monitoring or controlling components of a vehicle, comprising:
a controller having a processor and memory, wherein the controller is communicatively coupled to a plurality of input devices and a plurality of output devices;
wherein each of the plurality of input devices is disposed within the vehicle and the plurality of input devices comprises a first input device and a second input device, wherein the first input device is configured to transmit data in a first format and the second input device is configured to transmit data in a second format that is different from the first format;
wherein the first input device is a component of a first subsystem of the vehicle and the second input device is a component of a second, different subsystem of the vehicle;
wherein each of the plurality of output devices is disposed within the vehicle and the plurality of output devices comprises a first output device and a second output device;
wherein the controller is configured to analyze the received data from the first and second input devices and transmit a first command to the first output device based on the data received from the first or second input device.

2. The system of claim 1, wherein the first input device comprises a sensor configured to (i) monitor a status of a subsystem of the vehicle and (ii) generate the data.

3. The system of claim 1, wherein the first input device is configured to monitor at least one of an operational status of a component of the vehicle, a configuration status of the component of the vehicle, an equipment status of the component of the vehicle, a passenger request and a passenger interaction.

4. The system of claim 1, wherein the controller is further configured to transmit a second command to the first input device based on the data received from the first or second input device.

5. The system of claim 1, wherein the first input device comprises a portable computing device or a control panel of the vehicle that is configured to receive an input from a user and transmit the data to the controller based on the input.

6. The system of claim 5, wherein the first output device comprises the portable computing device or the control panel of the vehicle, and wherein the first output device is configured to display information based on the received first command from the controller.

7. The system of claim 1, wherein the first output device comprises an actuator and wherein the actuator causes a visual or physical change to the first output device based on the received first command from the controller.

8. The system of claim 7, wherein the first output device comprises at least one of a light source, a wireless access point, a HVAC subsystem, an overhead display, a seat-specific display, a power source, a passenger seat, and a status indicator.

9. The system of claim 1, wherein each of the plurality of input devices are communicatively coupled with the controller via a wired or wireless connection.

10. A control panel architecture for controlling two or more systems within a vehicle, comprising:
a processor communicatively coupled with a memory, wherein the processor is configured to receive an input from at least a first input device and a second input device, wherein the first input device is configured to transmit data in a first format and the second input device is configured to transmit data in a second format that is different from the first format;
wherein the first input device is a component of a first subsystem of the vehicle and the second input device is a component of a second, different subsystem of the vehicle;
wherein the processor is configured to analyze the received input or data in the first format from the first input device and the received input or data in the second format from the second input device and transmit a first command to a first output device based on the data received from the first or second input device; and
wherein the first output device comprises an actuator configured to cause a visual or physical change to the first output device based on the received first command.

11. The control panel architecture of claim 10, wherein the first input device comprises a sensor configured to (i) monitor a status of the first subsystem of the vehicle and (ii) generate the data.

12. The control panel architecture of claim 10, wherein the first input device is configured to monitor at least one of an operational status of a component of the vehicle, a configuration status of the component of the vehicle, an equipment status of the component of the vehicle, a passenger request and a passenger interaction.

13. The control panel architecture of claim 10, wherein the processor is further configured to transmit a second command to the first input device based on the data received from the first or second input device.

14. The control panel architecture of claim 10, wherein the first input device comprises a portable computing device or a control panel affixed in place within the vehicle that is configured to receive an input from a user and transmit the data to the controller based on the received input.

15. The control panel architecture of claim 14, wherein the first output device comprises the portable computing device or the control panel of the vehicle, and wherein the first output device is configured to display information based on the received first command.

16. The control panel architecture of claim 10, wherein the first output device comprises at least one of a light source, a wireless access point, a HVAC subsystem, an overhead display, a seat-specific display, a power source, a passenger seat, and a status indicator.

17. The control panel architecture of claim 10, wherein each of the plurality of input devices are communicatively coupled with the controller via a wired or wireless connection.

18. The control panel architecture of claim 10, wherein the processor is further configured to cause a display of a portable computing device or a control panel affixed in place within the vehicle to display information about a status of the first subsystem of the vehicle.

19. The control panel architecture of claim 18, wherein the status of the first subsystem comprises at least one of an operational status, a configuration status, and an equipment status.

20. The control panel architecture of claim 10, wherein the processor is wireless connected with the first and second input devices.
